(19) United States
(12) Patent Application Publication
(10) Pub. No.: US 2026/0154262 A1
(43) Pub. Date: Jun. 4, 2026

(54) SUBGRAPH QUERY METHOD AND APPARATUS

(71) Applicant: Alipay (Hangzhou) Digital Service Technology Co., Ltd., Hangzhou (CN)

(72) Inventors: Xintan ZENG, Hangzhou (CN); Yongchao Liu, Hangzhou (CN); Chuntao Hong, Hangzhou (CN)

(21) Appl. No.: 19/407,135

(22) Filed: Dec. 3, 2025

(30) Foreign Application Priority Data
Dec. 4, 2024 (CN) 202411779293.8

(51) Int. Cl. G06F 16/2453

(52) U.S. Cl. CPC G06F 16/24535

(57) ABSTRACT

A subgraph query method includes: obtaining a plurality of query subgraphs to be queried, wherein the plurality of query subgraphs include a node, an edge, and property information of the node and the edge; performing a preliminary query in a data graph stored in a graph database based on a same portion of the plurality of query subgraphs, to obtain a first query result of the same portion, wherein the same portion is included in the plurality of query subgraphs, and is a subgraph corresponding to a same edge in the plurality of query subgraphs; and separately performing a subgraph query in the data graph based on a remaining portion of the plurality of query subgraphs and the first query result, to obtain a query result of each query subgraph.

### CROSS-REFERENCE TO RELATED APPLICATIONS

This application claims priority to Chinese Patent Application No. 202411779293.8, filed on Dec. 4, 2024, the entire content of which is incorporated herein by reference.

### TECHNICAL FIELD

Embodiments of this specification relate to the field of graph database processing technologies, and in particular, to a subgraph query method and apparatus.

### BACKGROUND

In the computer field, a database is a data storage, management, and retrieval system. A relational database is a very common database type, and is usually used to store structured data. When a user submits a query, the database matches the query with data in the database. When matching succeeds, the database reads the data and returns the data to the user.

A non-relational database can be used to store unstructured data. For example, a graph database stores and queries data in a graph structure, and the data is stored in a form of a node and an edge. The node represents a data entity, and the edge represents a relationship between entities. The data stored in the graph database is also referred to as a data graph. When the user provides a query subgraph, the given query subgraph can be matched in the data graph, to obtain all isomorphic graphs of the query subgraph. The data graph includes privacy data of the user. When matching is performed on the data graph, it needs to be ensured that the privacy data is not disclosed.

Currently, it is expected that there can be an improved solution, to more efficiently perform subgraph matching on the data graph stored in the graph database.

### SUMMARY

Embodiments of this specification describe a subgraph query method and apparatus, to more efficiently perform subgraph matching on a data graph stored in a graph database.

According to a first aspect, an embodiment provides a subgraph query method, including: obtaining a plurality of query subgraphs to be queried, where the plurality of query subgraphs include a node, an edge, and property information of the node and the edge; performing a preliminary query in a data graph stored in a graph database based on the same portion of the plurality of query subgraphs, to obtain a first query result of the same portion, where the same portion is included in the plurality of query subgraphs, and is a subgraph corresponding to the same edge in the plurality of query subgraphs; and separately performing a subgraph query in the data graph based on a remaining portion of the plurality of query subgraphs and the first query result, to obtain a query result of each query subgraph.

According to a second aspect, an embodiment provides a subgraph query apparatus. The apparatus includes: a processor; and a memory storing instructions executable by the processor. The processor is configured to: obtain a plurality of query subgraphs to be queried, where the plurality of query subgraphs include a node, an edge, and property information of the node and the edge; perform a preliminary query in a data graph stored in a graph database based on the same portion of the plurality of query subgraphs, to obtain a first query result of the same portion, where the same portion is included in the plurality of query subgraphs, and is a subgraph corresponding to the same edge in the plurality of query subgraphs; and separately perform a subgraph query in the data graph based on a remaining portion of the plurality of query subgraphs and the first query result, to obtain a query result of each query subgraph.

According to a third aspect, an embodiment provides a non-transitory computer-readable storage medium storing a computer program that, when executed by a processor, causes the processor to perform a subgraph query method, the method including: obtaining a plurality of query subgraphs to be queried, where the plurality of query subgraphs include a node, an edge, and property information of the node and the edge; performing a preliminary query in a data graph stored in a graph database based on the same portion of the plurality of query subgraphs, to obtain a first query result of the same portion, where the same portion is included in the plurality of query subgraphs, and is a subgraph corresponding to the same edge in the plurality of query subgraphs; and separately performing a subgraph query in the data graph based on a remaining portion of the plurality of query subgraphs and the first query result, to obtain a query result of each query subgraph.

According to the method and the apparatus provided in the embodiments of this specification, the preliminary query is performed on the data graph stored in the graph database based on the same portion of the plurality of query subgraphs, to obtain the first query result. On this basis, the subgraph query continues to be performed on a remaining portion of each query subgraph, thereby reducing repeated matching of the same portion of a plurality of query subgraphs. In this way, subgraph matching can be performed more efficiently on the data graph stored in the graph database.

### BRIEF DESCRIPTION OF DRAWINGS

The following briefly describes the accompanying drawings of this specification. Clearly, the accompanying drawings in the following descriptions show merely example embodiments of this specification.

FIG. 1 is a schematic diagram of an implementation scenario according to an embodiment.

FIG. 2 is a flowchart of a subgraph query method according to an embodiment.

FIG. 3 is a flowchart of constructing a query tree according to an embodiment.

FIG. 4 is a schematic diagram of a class of edge data of a tree node according to an embodiment.

FIG. 5 is a block diagram of a subgraph query apparatus according to an embodiment.

FIG. 6 is a block diagram of a subgraph query apparatus according to an embodiment.

### DETAILED DESCRIPTION OF EMBODIMENTS

Example embodiments are described in detail below and represented in the accompanying drawings. When the following description relates to the accompanying drawings, unless specified otherwise, the same numbers in different accompanying drawings represent the same or similar elements. Implementations described in the following example embodiments do not represent all implementations consistent with this specification. On the contrary, the implementations are merely examples consistent with some aspects of one or more embodiments of this specification.

A graph database stores a large quantity of data graphs. The data graph is graph structure data constructed based on a large amount of service data. The data graph includes a large quantity of nodes, edges between nodes, and property information of the nodes and the edges. The node represents a data entity, and the edge represents a relationship between entities. The property information of the node and the property information of the edge include different meanings based on specific scenarios. For example, in a transaction scenario, the node represents a user, and the edge represents a transaction between users. The property information of the node is user property information, and can include a user account, a user property, user historical behavior information, etc. The property information of the edge is transaction property information, and can include a transaction number, a transaction amount, a transaction time, a transaction method, and transaction accounts of both parties. In a product push field, the nodes represent a user and a product, and the edge represents a behavior relationship (for example, a behavior relationship such as a tap, a search, or a view) between the user and the product. Property information of a user node is user property information, property information of a product node is product property information and can include product information, and property information of the edge includes behavior-related information, etc. In addition, the data in the data graph can be data in another service field. It should be noted that user-related information includes a user property, a transaction property, etc., which are privacy data, for which privacy preserving needs to be performed in a data processing process. In addition, the above-mentioned user-related privacy data is obtained after the user grants authority.

A query subgraph is small graph structure data relative to the data graph. The query subgraph includes a node and an edge, and can include a plurality of nodes and a plurality of edges, and include at least two nodes and one edge between the two nodes. The query subgraph is a specific pattern graph, of a specified structure, that is determined in some known methods, for example, can be a specific pattern graph with a transaction risk structure. The query subgraph includes specific nodes and edges, and the nodes and edges form a graph pattern that needs to be matched.

A subgraph query is searching the data graph for all subgraphs that are isomorphic to the query subgraph. A purpose of the subgraph query is to find, in a given large graph, all subgraphs that are isomorphic to a given small graph. The query subgraph is a small graph used for a query in subgraph matching. In the transaction risk prediction field, a subgraph found in the data graph based on the query subgraph is a transaction that includes a risk, and risk prediction can be performed based on these subgraphs, to more quickly determine a service risk and eliminate the service risk.

The found subgraph and the query subgraph are isomorphic graphs. There is one-to-one mapping between node sets of two graphs that are isomorphic graphs, and edges between corresponding vertices are also kept in one-to-one correspondence. In the two isomorphic graphs, a group of nodes corresponding to each other have the same node property information, and a group of nodes corresponding to each other have the same node property information.

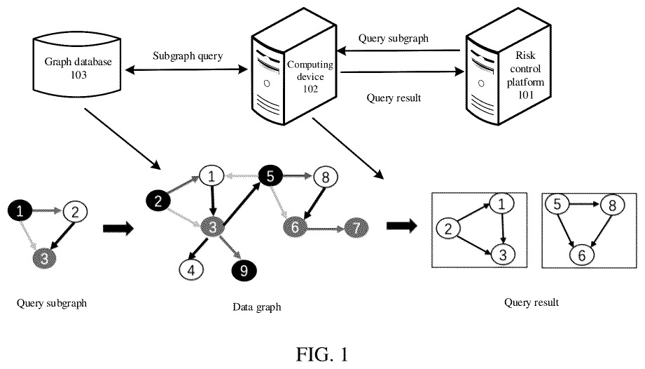

FIG. 1 is a schematic diagram of an implementation scenario according to an embodiment. A risk control platform 101, a computing device 102, and a graph database 103 are included. The risk control platform 101 is configured to send a query subgraph to the computing device 102. The computing device 102 is configured to: perform a subgraph query in the graph database 103 based on the query subgraph, and send an obtained query result to the risk control platform 101. The risk control platform 101 is configured to perform risk prediction based on the query result. The graph database 103 is configured to store data in a data graph. FIG. 1 further provides a schematic diagram of the query subgraph, the data graph, and the query result. Grayscales of nodes and edges represent corresponding node properties and edge properties, numbers in circles are node numbers, and numbers of corresponding nodes in a found user subgraph and the query subgraph may be different. For example, an edge 1→2 in the query subgraph corresponds to an edge 2→1 in the user subgraph, but the node numbers are different. FIG. 1 is only a schematic diagram of a scenario in this embodiment. In actual applications, this embodiment can be further applied to a plurality of implementation scenarios.

In an actual application scenario of the subgraph query, there is usually more than one subgraph query. Therefore, a batch subgraph query is needed. The batch subgraph query is performing a subgraph query in the data graph by using a plurality of query subgraphs.

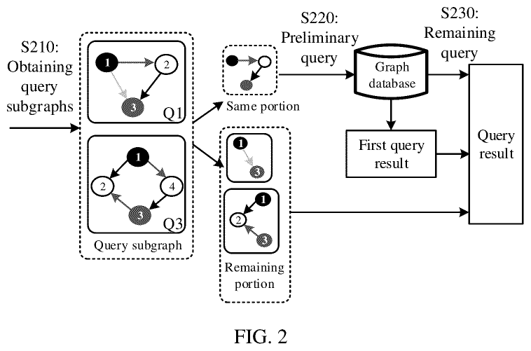

To improve efficiency of a batch subgraph query process, an embodiment of this specification provides a subgraph query method. The following describes this embodiment with reference to FIG. 2.

FIG. 2 is a flowchart of a subgraph query method according to an embodiment. A data graph includes a large quantity of nodes and an edge between the nodes, and the edge can have a direction, or can have no direction. The method can be performed by a computing device. In the scenario shown in FIG. 1, for example, the method can be performed by the computing device 102 in FIG. 1. The method may include the following steps.

Step S210: Obtain a plurality of query subgraphs Q to be queried, where the plurality of query subgraphs include one or more query subgraphs, each query subgraph Q includes at least two nodes and a connection edge between the nodes, property information of the node, and property information of the edge.

Step S220: Perform a preliminary query in a data graph G stored in a graph database based on the same portion of the plurality of query subgraphs, to obtain a first query result of the same portion.

The same portion is included in the plurality of query subgraphs, and is a subgraph corresponding to the same edge in the plurality of query subgraphs. The plurality of query subgraphs can have one or more same edges. Any same edge includes the same edge property information, and the same property information of two nodes connected to the edge.

In an example, the plurality of query subgraphs Q include a first query subgraph Q1, a third query subgraph Q3, etc. The two query subgraphs Q have the same portion and different portions. An edge 1→2 in the first query subgraph Q1 is the same as an edge 1→4 in the third query subgraph Q3, and an edge 2→3 in the first query subgraph Q1 is the same as an edge 4→3 in the third query subgraph Q3. Therefore, the same portion is formed by sequentially passing through a black dot (dot 1 in each of Q1 and Q3), a blue line (line between dot 1 and dot 2 in Q1; line between dot 1 and dot 4 in Q3), a white dot (dot 2 in Q1 and dot 4 in Q3), a black line (line between dot 2 and dot 3 in Q1; line between dot 4 and dot 3 in Q3), and a blue dot (dot 3 in each of Q1 and Q3). The remaining portion is different portions of the two query subgraphs. In the first query subgraph Q1, the remaining portion is a portion including the black dot (dot 1), a yellow line (line between dot 1 and dot 3), and the blue dot (dot 3). In the third query subgraph Q3, the remaining portion is a portion including the black dot (dot 1), a black line (line between dot 1 and dot 2), a white dot (dot 2), a blue line (line between dot 2 and dot 3), and the blue dot (dot 3). For illustration purposes, colors of a dot and a line are used to represent node properties and edge properties, and grayscales corresponding to the colors are shown in FIG. 2.

The first query result is only intermediate data in a subgraph query process, and is not an obtained final query result.

When this step is performed, edges included in the plurality of query subgraphs Q can be compared, to determine the same portion of the plurality of query subgraphs Q, and the same portion of the plurality of query subgraphs Q is combined into one or more graphs. A quantity of combined graphs is less than a quantity of the plurality of query subgraphs Q. That is, the same portion can be understood as a graph including nodes and an edge between the nodes. Usually, the same portion can be a continuous portion in the plurality of query subgraphs Q.

When the preliminary query is performed in the data graph G based on the same portion, the same portion can be used as a query subgraph. In an embodiment, a subgraph query is performed in the data graph G by using the same portion.

Step S230: Separately perform a subgraph query in the data graph G based on a remaining portion of the plurality of query subgraphs and the first query result, to obtain a query result of each query subgraph Q. A query result of each query subgraph Q includes one or more subgraphs. In the transaction risk control field, the query result is used to perform transaction risk prediction.

After the first query result of the same portion is obtained, because the same portion is associated with the remaining portion of each query subgraph Q, the subgraph query can continue to be performed on a remaining portion based on the first query result corresponding to the same portion, to obtain a complete subgraph query result corresponding to each query subgraph Q, For example, the subgraph query can continue to be performed on a remaining portion of any first query subgraph Q1 in a data graph range included in the first query result, to obtain a query result corresponding to the first query subgraph Q1. The remaining portion of each query subgraph Q is also a query subgraph. The query subgraph can be queried in an existing manner.

In the graph database query method provided in this embodiment, because the preliminary query is performed in the data graph G by using the same portion, subgraph matching continues to be performed on the remaining portion of each query subgraph based on the obtained first query result, and it is unnecessary to perform repeated subgraph matching on the same portion, thereby reducing a calculation amount during a query, and improving efficiency of a batch subgraph query.

To improve query efficiency, in another embodiment of this specification, a step of obtaining the same portion of the plurality of query subgraphs Q can be further included between step S210 and step S220 in the embodiment in FIG. 2. In an implementation, the step of obtaining the same portion of the plurality of query subgraphs Q can be implemented in step 1, and steps S220 and S230 can be implemented in step 2.

Step 1: Combine the plurality of query subgraphs Q into a query tree T.

A backbone portion of the query tree T is the same portion of the plurality of query subgraphs Q1, the remaining portion of the any query subgraph Q is a branch portion of the query tree T, and a plurality of paths included in the query tree T respectively correspond to the plurality of query subgraphs Q. The query tree T includes a plurality of tree nodes, and the plurality of tree nodes form a plurality of paths from a root node to a leaf node.

Step 2: Perform a subgraph query in the data graph G based on the query tree T in a sequence from the backbone portion to the branch portion of the query tree T, to obtain query results respectively corresponding to the plurality of query subgraphs Q. Step 2 can specifically include step 2_1 and step 2_2.

Step 2_1: Perform the preliminary query. The preliminary query includes: performing the subgraph query in the data graph G stored in the graph database based on the backbone portion of the query tree T, to obtain the first query result.

Step 2_2: Remaining query. The remaining query includes: performing the subgraph query based on the branch portion of the query tree T based on the first query result.

In this embodiment, the plurality of query subgraphs Q are combined into the query tree T, so that as many same portions of the plurality of query subgraphs Q as possible are combined, thereby avoiding repeated queries as much as possible, and improving query efficiency.

In step 1, because there is a connection relationship between the node and the edge in the query subgraph, and there is a connection relationship between tree nodes in the query tree T, based on this similarity feature, a plurality of query subgraphs Q can be combined into a query tree T, so that a backbone portion of the query tree T includes the same portion, and a plurality of paths included in the query tree T respectively correspond to the plurality of query subgraphs Q. Based on this idea, the plurality of query subgraphs Q can be combined into the query tree T in a plurality of implementations. The following describes an execution process of step 1 with reference to a specific implementation.

In an implementation, for any first query subgraph Q1 in the plurality of query subgraphs Q, the first query subgraph Q1 includes a plurality of edges and a matching order of the first query subgraph Q1, and an edge included in the same portion has a corresponding same matching order in different query subgraphs Q. In this case, step 1 can be performed in the following manner:
The edge included in the first query subgraph Q1 is used as a tree node in the query tree T, and the first query subgraph Q1 is combined into the query tree T based on the matching order of the edges in the first query subgraph Q1, so that a plurality of edges of the same portion are sequentially combined into the backbone portion of the query tree T, and a different portion (namely, a remaining portion) of the first query subgraph Q1 relative to another query subgraph Q is combined into the branch portion of the query tree T. The edge in the query subgraph Q is used as a tree node in the query tree T, each tree node is an edge in the query subgraph Q, edge data in the query subgraph Q can be directly used to determine data of the tree node. This correspondence can reduce complexity of constructing the data of the tree node.

Herein and a subsequent portion are described by using an operation performed on any first query subgraph Q1 as an example. For another query subgraph Q1, the same or similar operation is performed.

The edge is a minimum matching unit in a subgraph matching process. In the subgraph query process, an edge and two nodes connected to the edge form a basic unit of matching. The matching order is a query order of an edge when a subgraph query is separately performed in the data graph G by using the query subgraph. For example, in FIG. 2, the edge 1→2 in the first query subgraph Q1 is a matching unit of a query. The edge 2→3 and an edge 1→3 are different matching units. Each edge of the query subgraph Q1 and a matching order of each edge can be represented as follows:
edges[0]: {node 1, node 2, black, white, blue}
edges[1]: {node 2, node 3, white, blue, black}
edges[2]: {node 1, node 3, black, blue, yellow}

Herein, edges[0] is used as an example, and edges[0] is an identifier of an edge. 0 indicates a matching order of the edge, and content in braces is sequentially a source node, a target node, a source node color, a target node color, and an edge color in the edge.

Each edge of the third query subgraph Q3 and a matching order of each edge can be represented as follows:
edges[0]: {node 1, node 4, black, white, blue}
edges[1]: {node 4, node 3, white, blue, black}
edges[2]: {node 3, node 2, blue, white, blue}
edges[3]: {node 2, node 1, white, black, black}

It can be seen that the same portion between the first query subgraph Q1 and the third query subgraph Q3 is the edge edges[0] and the edge edges[1]. That the edges included in the same portion have the same matching order corresponding to the plurality of query subgraphs Q can be understood as follows: The matching order of the same portion in the first query subgraph Q1 is the same as the matching order of the same portion in the third query subgraph Q3. That is, a matching order of the edge edges[0] and the edge edges[1] in the two query subgraphs is 0 and 1.

The query tree is a type of tree structure data. The tree structure data can be constructed in a manner such as Top-Down (starting from a root node) and Bottom-Up (starting from a leaf node). When the plurality of edges in the first query subgraph Q1 are combined into the query tree T based on the matching order of the first query subgraph Q1, the query tree T can be constructed in a sequence of top-down or bottom-up.

In an implementation, the edge may not be used as a tree node; instead, the node in the first query subgraph Q1 is used as a tree node in the query tree T, and the edge in the first query subgraph Q1 is used as an edge between tree nodes in the query tree T, or the node and the edge in the first query subgraph Q1 are used as tree nodes in the query tree T.

The following describes an example construction process of the query tree T. In an implementation of constructing the query tree T by using the edge as a tree node in the query tree T and based on the matching order of the edges included in the first query subgraph Q1, a correspondence between a matching order of edges included in the same portion and a construction sequence of the query tree T can be set, so that the first query subgraph Q1 is combined into the query tree T.

For example, after the matching order of the edges included in the same portion can be listed after a matching order of another edge, when the first query subgraph Q1 is combined into the query tree T, the following operation is performed in the following manner: merging the first query subgraph Q1 into the query tree T based on the matching order of the plurality of edges in the first query subgraph Q1 and in a sequence from the leaf child node to the root node in the query tree T.

Alternatively, the first query subgraph Q1 is set as follows: the matching order of the edges included in the same portion is before a matching order of another edge. In this case, when the first query subgraph Q1 is combined into the query tree T, the following operation is performed in the following manner: merging the first query subgraph Q1 into the query tree T based on the matching order of the plurality of edges in the first query subgraph Q1 and in a sequence from a root node to a leaf node in the query tree.

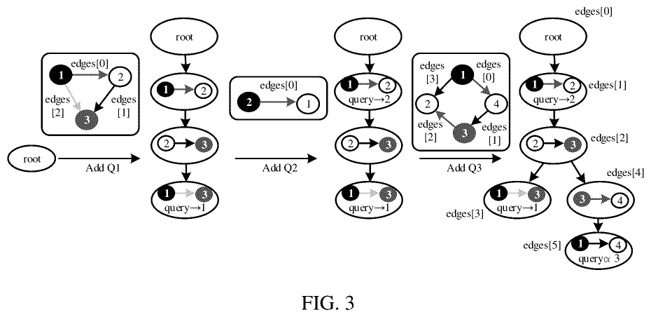

This matching merging manner can make it easier for the plurality of edges of the same portion to be sequentially combined into the backbone portion of the query tree T. The following describes in details the construction process of the query tree T with reference to FIG. 3 by using the latter manner as an example.

FIG. 3 is a schematic diagram of constructing a query tree according to an embodiment. From left to right, a process of sequentially merging a plurality of query subgraphs Q1 to Q3 into the query tree T is listed. Similar to FIG. 2, colors of a dot and a line are used to represent node properties and edge properties, and grayscales corresponding to the colors are shown in FIG. 3.

When the first query subgraph Q1 is the 1^{st} query subgraph to be combined into the query tree T, only the root node exists in the query tree T, and no child node exists. The root node can be set as an empty node, and is a tree node that does not include an edge. In this case, the following step can be performed: using an edge in a current matching order in the first query subgraph Q1 as a parent node in the query tree T based on the matching order, and using an edge in the next matching order as a child node of the parent node.

In FIG. 3, the edge that is in the current matching order can be any one of edges[0], edges[1], and edges[2]. For example, starting from the 1^{st} edge edges[0], the 1^{st} edge is used as a parent node in the query tree T, the next edge edges[1] is used as a child node of the root node, and the edge edges[2] is used as a child node of the next level of the child node. Therefore, a plurality of edges in the first query subgraph Q1 are sequentially added to the query tree T. When a leaf node of a last level is reached, the leaf node points to the first query subgraph Q1, that is, query→1 is set, to indicate that a path from the root node to the leaf node corresponds to the first query subgraph Q1.

When the second query subgraph Q2 is not the 1^{st} query subgraph to be combined into the query tree T, a plurality of tree nodes exist in the query tree T, and the tree node includes an edge. In this case, the second query subgraph Q2 can be combined into the query tree T in the following implementation.

A first edge is determined from the second query subgraph Q2 based on the matching order, a first tree node is determined from the query tree T in a sequence from the parent node to the child node, and iterative merging is performed in step 1_1 to step 1_3.

Step 1_1: Determine whether the first edge is capable of being combined with an edge in a child node of the first tree node, and perform step 1_2 if yes, or perform step 1_3 if not.

Step 1_2: Update the first edge and the first tree node.

Step 1_3: Sequentially use the first edge and another edge in the second query subgraph Q2 as child nodes of levels of the first tree node.

In this implementation, the root node is preset to an empty node, and is a tree node that does not include an edge. Therefore, the root node is initially used as the first tree node, and the first edge and the edge of the child node of the first tree node is determined for merging. The above-mentioned matching order is a matching order of a plurality of edges in the second query subgraph Q2. Initially, an edge in a first matching order, namely, the 1^{st} edge, is used as the first edge.

When whether merging can be performed is determined, whether the first edge matches edge property information of any child node included in the first tree node can be determined. That is, if the first edge can be completely the same as an edge of any child node of the first tree node, it is considered that the first edge matches the edge of the any child node. If the first edge is not completely the same as edges of all child nodes of the first tree node, it is considered that the first edge does not match the edges of all the child nodes. If the first edge matches the edge of the any child node, it indicates that a determining result of step 1_1 is yes. If the first edge does not match the edges of all the child nodes, it indicates that a determining result of step 1_1 is not.

For example, execution of step 1_1 includes a loop process. That is, whether the first edge is capable of being combined with an edge of one child node of the first tree node is determined. If not, whether the first edge is capable of being combined with an edge of another child node of the first tree node is determined, until all child nodes of the first tree node are determined. If the first edge is incapable of being combined with edges of all nodes, it is determined that a determining result of step 1_1 is not. If one of all child nodes of the first tree node can be combined with the first edge, a loop stops, and it is determined that a determining result of step 1_1 is yes.

When whether the first edge matches any child node (for example, a first child node) included in the first tree node is determined, whether the first edge matches an edge of the first child node, that is, whether node property information of an edge is correspondingly the same as edge property information can be determined through comparison. If both are the same, it is determined that the first edge matches the child node. During matching, the generally mentioned edge includes a head/tail node and an edge between head/tail nodes.

When the first edge and the first tree node are updated in step 1_2, an edge in the next matching order in the second query subgraph Q2 can be updated to the first edge, and a child node (for example, the first child node) that is determined to be capable of being combined in the child node of the first tree node is updated to the first tree node.

In step 1_3, the first edge is used as a child node of the first tree node, and the next edge of the first edge is used as a child node of the child node, until all remaining edges in the second query subgraph Q2 are added to the query tree T.

After step 1_2 or step 1_3, step 1_1 is performed, thereby iteratively performing determining and merging.

FIG. 3 is used as an example. The first edge is the edge edges[0] in subgraph Q2, the first tree node in the query tree T is a root node, and the root node has only one child node. The edge edges[0] is matched with the edge in the child node of the root node, and it is found that the source node color, the target node color, and the edge color are all correspondingly the same. That is, node property information and edge property information are corresponding the same. In this case, it is determined that the edge edges[0] and the edge in the child node of the root node can be combined. Because there is only one edge in the second query subgraph Q2, the child node of the root node can point to the second query subgraph Q2, that is, query→2 is set, to indicate that a path from the root node to the child node corresponds to the second query subgraph Q2.

Similarly, the third query subgraph Q2 includes edges edges[0], edges[1], edges[2], and edges[3]. A number in square brackets [ ] indicates a matching order. The 1^{st} edge edges[0] and the edge of the child node of the root node (that is, the 2^{nd} tree node starting from the top of the query tree T) are determined for merging. If a determining result is that merging can be performed, the 2^{nd} edge edges[1] and an edge of a child node (namely, a third tree node starting from the top of the query tree T) of the next level continue to be determined for merging. If a determining result is that merging can be performed, the 3^{rd} edge edges[2] and an edge of a child node (namely, the 4^{th} tree node starting from the top of the query tree T, for which, refer to the query tree T on the right of Q3) of the next level continue to be determined for merging. If a determining result is not, the 3^{rd} edge edges[2] can be added to the query tree T as a new child node, that is, a child node that is parallel to the 4^{th} tree node, and the 4^{th} edge edges[3] continues to be used as a child node of the next level of the child node. A leaf node of the last level points to the third query subgraph Q3, that is, query→3 is set, to indicate that a path from the root node to the leaf node corresponds to the third query subgraph Q3.

To create the tree node of the query tree T, regardless of whether the query subgraph is the 1^{st} subgraph or not the 1^{st} subgraph, a plurality of edges of the query subgraph need to be added to or combined into the query tree T as tree nodes in the query tree T, which is essentially edge data for creating the tree node.

For example, when a first edge in a query subgraph is used as a tree node in the query tree T, edge data of the tree node can be determined based on edge data of the first edge. The first edge is any edge that needs to be added to the query tree.

The edge data corresponding to the tree node can include an identifier of the tree node and a child node of the tree node, and an identifier used to indicate whether an edge of the tree node is the last edge in a query subgraph. The identifier can be represented by a pointing parameter (query). When an edge is the last edge of a query subgraph, the pointing parameter points to the query subgraph. In addition, the edge data of the tree node can further include a node identifier, an edge identifier, edge property information, node property information, etc. in an edge. The edge identifier can be used as an identifier of the tree node.

Usually, to make internal numbers of the query tree T consistent, nodes and edges in the query tree T can be renumbered, that is, node identifiers and edge identifiers are redetermined.

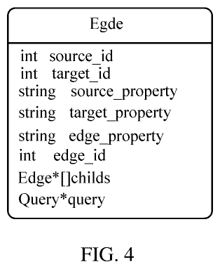

The edge data of the tree node can be recorded based on a class of the tree node. FIG. 4 is a schematic diagram of a class of edge data of a tree node according to an embodiment. The following data of the edge is included: an integer variable (int) source node identifier (source_id), a target node identifier (target_id), a string variable (string) source node property (source_property), a target node property (target_property), an edge property (edge_property), an integer variable edge identifier (edge_id), a child node (Edge*[ ]childs) of the tree node, and a pointing parameter (Query*query). edge_id is also used to identify a tree node, in the query tree T, that corresponds to the edge.

As mentioned above, the node identifier and the edge identifier in the query tree T can be redetermined. To more accurately determine the node identifier in the query tree in the process of creating the query tree T, a mapping relationship table (id_mapping) can be maintained in a process of merging a query subgraph into the query tree T. The mapping relationship is used to record a mapping relationship between the node identifier in the query subgraph and the node identifier in the query tree T.

When the edge data of the tree node is determined based on the edge data of the first edge, the following steps can be performed: when a node identifier of the first edge is recorded in a mapping relationship, directly generating a node identifier of the tree node, and recording a correspondence between the node identifier in the query subgraph and the node identifier in the query tree T; or when a node identifier of the first edge is not recorded in a mapping relationship, determining a node identifier of the tree node based on the node identifier in the tree node corresponding to the node identifier in the mapping relationship. For example, the node identifier in the tree node corresponding to the node identifier in the mapping relationship can be determined as the node identifier of the tree node, to avoid repeatedly generating a new node identifier.

The following describes in detail a process of merging a query graph by using an example and with reference to the class in FIG. 4.

An empty Edge class is created, and is used as the root node of the query tree. A property “edge_id” is set to 0, and the rest is empty.

An integer variable max_vertex_id is defined, to assist in helping generate a tree node identifier (ID) in the query tree T, which is initialized to 1.

An integer variable max_edge_id is defined, to assist in helping generate an edge ID in the query tree T, which is initialized to 1, because 0 is already occupied by the root node.

For any query subgraph, the following preprocessing is performed:

A temporary pointer parent pointing to the root node in the query tree T is defined, to represent a current parent node (namely, the first tree node mentioned above).

An empty temporary mapping relationship table id_mapping is created, to store a mapping relationship between a node ID (key) in the query subgraph and the node ID (value) in the edge of the tree node in the query tree, where both IDs are integer variables int, and are stored in a form of a key-value pair.

After the above-mentioned preprocessing is performed, for the query subgraph, the query subgraph is combined into the query tree T in step 1_4 to step 1_10.

Step 1_4: Traverse all edges in the query subgraph abased on a matching order, and use a current edge as q_edge (namely, the first edge mentioned above).

Step 1_5: Traverse all child nodes of the pointer parent, where a current child node is referred to as an edge t_edge.

Step 1_6: Determine whether the edge q_edge and the edge t_edge can be combined.

A specific determining process can include:
If source_property of q_edge is different from source_property of t_edge, not is returned. Otherwise, yes is returned.

If target_property of q_edge is different from target_property of t_edge, not is returned. Otherwise, yes is returned.

If edge_property of q_edge is different from edge_property of t_edge, not is returned. Otherwise, yes is returned.

If source_id of q_edge does not exist in a key of id_mapping, yes is returned. If source_id of q_edge exists in a key of id_mapping, if a value of id_mapping[q_edge.source_id] is different from source_id of t_edge in the class, not is returned; or if a value of id_mapping[q_edge.source_id] is the same as source_id of t_edge in the class, yes is returned.

If target_id of q_edge does not exist in a key of id_mapping, yes is returned. If target_id of q_edge exists in a key of id_mapping, if a value of id_mapping[q_edge.target_id] is different from target_id of t_edge in the class, no is returned; or if a value of id_mapping[q_edge.target_id] is the same as target_id of t_edge in the class, yes is returned.

During determining, if a result of any one of a plurality of determining options is not, it indicates that merging cannot be performed. If yes is for all the determining options, it indicates that merging can be performed.

Step 1_7: If merging can be performed, store a mapping relationship of the node ID in the mapping relationship table id mapping, change the pointer parent to point to the edge t_edge, return to step 1_4, and continue the next edge q_edge.

When the mapping relationship of the node ID is stored, a form can be stored in the following form of key-value pair:
id_mapping[q_edge.source_id]=t_edge.source_id; and
id_mapping[q_edge.target_id]=t_edge.target_id.

Step 1_8: If merging cannot be performed, return to step 1_5, and continue to use the next child node of the pointer parent as the edge t_edge.

Step 1_9: If no child node of the pointer parent can be combined with the edge q_edge, or the pointer parent has no child node at all, perform step 1_9_1 to step 1_9_6.

Step 1_9_1: Directly add the current edge q_edge to the pointer parent->childs[ ] as a new child node of the parent node.

Step 1_9_2: Set edge_id in a class of a newly added tree node as a value of max_edge_id, and increase the value of max_edge_id by 1.

Step 1_9_3: For the newly added tree node, when an edge is placed in the query tree T from the query subgraph, a node ID of the edge needs to be changed to a node ID corresponding to the newly added tree node in the query tree T. Specifically, a node ID in the class of the newly added tree node can be modified in the following manner:
If source_id of the edge q_edge exists in the key of id_mapping, source_id in the class of the newly added tree node is added to a value corresponding to id_mapping[q_edge.source_id].

If source_id of the edge q_edge does not exist in the key of id_mapping, source_id in the class of the newly added tree node is set to the value of max_vertex_id, a correspondence is stored in id _mapping, and the value of max_vertex_id is increased by 1.

If target_id of the edge q_edge exists in the key of id_mapping, target_id in the class of the newly added tree node is added to a value corresponding to id_mapping[q_edge.target_id].

If target_id of the edge q_edge does not exist in a key of id_mapping, target_id in the class of the newly added tree node is set to a value of max_vertex_id, a correspondence is stored in id _mapping, and the value of max_vertex_id is increased by 1.

Step 1_9_4: Use property information in a class of the edge q_edge as corresponding property information in the class of the newly added tree node, including [source_property], [target_property], [edge_property], etc. in the class.

Step 1_9_5: Change the pointer parent to point to a tree node added to a current query tree.

Step 1_9_6: Return to step 1_4, and use an edge in the next matching order in the query subgraph as q_edge.

Step 1_10: If the edge q_edge is the last edge in the query subgraph, set a query in a class of a corresponding tree node to point to the query subgraph.

The foregoing describes, by using a specific example, a process of merging the query subgraph into the query tree T. The plurality of query subgraphs Q are combined into the query tree T, and the obtained query tree T can be referred to a graph on the rightmost side in FIG. 3. An edge ID of each tree node is marked next to the tree node, that is, from edge[0] to edge[5]. It can be learned from the embodiment in FIG. 3 that, in the process of merging the plurality of query subgraphs Q into the query tree, a front and same matching order in the plurality of query subgraphs Q is preset for the same portion, thereby more conveniently merging the same portion into the backbone portion of the query tree T.

After the plurality of query subgraphs Q are combined into the query tree T, a subgraph matching procedure also changes correspondingly. Instead of taking out the next edge from edges[ ] in the plurality of query subgraphs Q, the next edge is taken out from the current tree node in the query tree T.

The following further describes a specific implementation of step 2. In step 2_1, when the subgraph query is performed in the data graph G stored in the graph database based on the backbone portion of the query tree T, specifically, the following steps can be performed:
When the edge of the first tree node is a to-be-queried edge of the backbone portion, a subgraph query is performed on the to-be-queried edge in the data graph G based on a subgraph, in the data graph G, that matches an edge of the parent node of the first tree node. For example, the edge of the first tree node is matched in a subgraph range, in the data graph G, that matches an edge of the parent node of the first tree node, to gradually narrow a query range.

In addition, in step 2_2, when the subgraph query is performed based on the branch portion of the query tree T and the first query result, the subgraph query can be performed based on the branch portion of the query tree T within a range included in the first query result. When the edge of the first tree node is a to-be-queried edge of the branch portion, a subgraph query is performed on the to-be-queried edge in the data graph G based on a subgraph, in the data graph, that is found based on an edge of the parent node of the first tree node.

When the first tree node is the last tree node in a corresponding path of the first query subgraph Q1 in the query tree T, the query result corresponding to the first query subgraph Q1 is determined based on the query result of the to-be-queried subgraph in the data graph G. For example, a subgraph query result of the last tree node in the data graph G can be directly used as the query result corresponding to the first query subgraph Q1.

The first tree node is any tree node in the query tree T. When no edge is included in the root node, the first tree node can be one or more of all tree nodes other than the root node.

A query tree T obtained on the rightmost side in FIG. 3 is used as an example. For the query tree T on the rightmost side in FIG. 3, a subgraph query is performed on the edge of the tree node in the data graph G in the sequence from the backbone portion to the branch portion of the query tree T. For example, a subgraph query is performed on the tree node edge[1] in the data graph G, to obtain a matching result 1. Because the query in edge[1] points to the second query subgraph Q2, the matching result 1 is a query result corresponding to the second query subgraph Q2 in the data graph G.

Then, based on the matching result 1, a subgraph query is performed on the tree node edge[2] in the data graph G, to obtain a matching result 2. Based on the matching result 2, a subgraph query is performed on the tree node edge[3] in the data graph G, to obtain a matching result 3. Because the query in edge[3] points to the first query subgraph Q1, the matching result 3 is a query result corresponding to the first query subgraph Q1 in the data graph G.

Then, based on the matching result 2, a subgraph query is performed on the tree node edge[4] in the data graph G, to obtain a matching result 4. Based on the matching result 4, a subgraph query is performed on the tree node edge[5] in the data graph G, to obtain a matching result 5. Because the query in edge[5] points to the third query subgraph Q3, the matching result 5 is a query result corresponding to the third query subgraph Q3 in the data graph G.

It can be learned from the above-mentioned example that subgraph query results of the tree nodes edge[1] and edge[2] are reused in the subgraph query process. In this embodiment, repeated matching of the edge in the data graph G is avoided, a resource waste is reduced, a matching time of a user subgraph is stored, and a query result can be obtained more efficiently. In the transaction risk control field, an efficient subgraph query can improve risk prediction efficiency.

In this specification, “first” in words such as the first query subgraph, the first tree node, and the first edge and corresponding “second” (if present) in the specification, etc. are merely used for ease of distinguishing and description, and have no limitation meaning.

In this specification, the computing device and the risk control platform can be implemented by any apparatus, device, platform, device cluster, etc. having computing and processing capabilities.

Example embodiments of this specification are described above, and other embodiments fall within the scope of the appended claims. In some cases, the actions or steps described in the claims can be performed in a sequence different from that in the embodiments and desired results can still be achieved. In addition, the process depicted in the accompanying drawings does not necessarily need the shown particular sequence or consecutive sequence to achieve the desired results. In some implementations, multitasking and parallel processing are possible or may be advantageous.

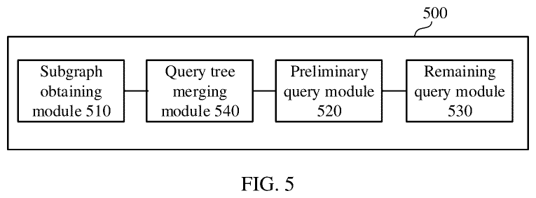

FIG. 5 is a block diagram of a subgraph query apparatus 500 according to an embodiment. This apparatus embodiment corresponds to the method embodiment shown in FIG. 2. The apparatus 500 includes:
a subgraph obtaining module 510, configured to obtain a plurality of query subgraphs to be queried, where the plurality of query subgraphs include a node, an edge, and property information of the node and the edge;
a preliminary query module 520, configured to perform a preliminary query in a data graph stored in a graph database based on the same portion of the plurality of query subgraphs, to obtain a first query result of the same portion, where the same portion is included in the plurality of query subgraphs, and is a subgraph corresponding to the same edge in the plurality of query subgraphs; and
a remaining query module 530, configured to separately perform a subgraph query in the data graph based on a remaining portion of the plurality of query subgraphs and the first query result, to obtain a query result of each query subgraph.

In an implementation, the apparatus 500 further includes: a query tree merging module 540, configured to obtain the same portion of the plurality of query subgraphs in the following manner: merging the plurality of query subgraphs into a query tree, where a backbone portion of the query tree is the same portion of the plurality of query subgraphs.

In an implementation, a remaining portion of any query subgraph is a branch portion of the query tree.

In an implementation, any first query subgraph includes a plurality of edges and a matching order of the plurality of edges, an edge included in the same portion has a corresponding same matching order in different query subgraphs, and the query tree merging module 540 is specifically configured to: use the edge in the first query subgraph as a tree node in the query tree, and merge the first query subgraph into the query tree based on the matching order, so that a plurality of edges included in the same portion are sequentially combined into the backbone portion of the query tree.

In an implementation, in first query subgraph, the edges included in the same portion have a matching order prior to a matching order of another edge. When the query tree merging module 540 merges the first query subgraph into the query tree, the following operation is included:
merging the first query subgraph into the query tree based on the matching order of the plurality of edges in the first query subgraph and in a sequence from a root node to a leaf node in the query tree.

In an implementation, when the query tree merging module 540 merges the first query subgraph into the query tree, the following operations are included:
when the first query subgraph is the 1^{st} subgraph, using an edge in a current matching order in the first query subgraph as a parent node in the query tree based on the matching order, and using an edge in the next matching order as a child node of the parent node.

In an implementation, the step in which the query tree merging module 540 merges the first query subgraph into the query tree includes:
when the first query subgraph is not the 1^{st} subgraph, determining a first edge from the first query subgraph based on the matching order, determining a first tree node from the query tree in a sequence from the parent node to the child node, and performing iterative merging in the following manner:
determining whether the first edge is capable of being combined with an edge of a child node of the first tree node; and
if yes, updating the first edge and the first tree node; or
if not, sequentially using the first edge and another edge in the first query subgraph as child nodes of levels of the first tree node,
In an implementation, when the query tree merging module 540 determines whether the first edge is capable of being combined with the child node of the first tree node, the following operation is included:
when the first edge matches an edge of any child node included in the first tree node, determining that the first edge is capable of being combined with the edge of the any child node included in the first tree node.

In an implementation, the tree node in the query tree has corresponding edge data, and the edge data includes an identifier of the tree node and a child node of the tree node, and an identifier used to indicate whether an edge of the tree node is a last edge in a query subgraph. When the query tree merging module 540 uses a first edge in a query subgraph as a tree node in the query tree, the following operation is included: determining edge data of the tree node based on edge data of the first edge.

In an implementation, edge data of the tree node further includes a node identifier and an edge identifier that correspond to an edge, and the edge identifier is used as an identifier of the tree node. When the query tree merging module 540 determines the edge data of the tree node based on the edge data of the first edge, the following operation is included:
when a mapping relationship library records a node identifier of the first edge, determining a node identifier of a tree node based on the node identifier of the tree node corresponding to the node identifier in the mapping relationship library, where the mapping relationship library is configured to record a mapping relationship between a node identifier in the query subgraph and a node identifier in the query tree.

In an implementation, the preliminary query module 520 is specifically configured to perform the subgraph query in the data graph stored in the graph database based on the backbone portion of the query tree, and the remaining query module 530 is specifically configured to separately perform the subgraph query based on the branch portion of the query tree and the first query result.

In an implementation, when the preliminary query module 520 performs the subgraph query in the data graph stored in the graph database based on the backbone portion of the query tree, the following operations are included: when an edge of the first tree node is a to-be-queried edge, performing the subgraph query in the to-be-queried edge in the data graph based on a subgraph found in the data graph based on an edge of a parent node of the first tree node.

In an implementation, when the remaining query module 530 performs the subgraph query based on the branch portion of the query tree, the following operation is included: when the first tree node is a last tree node in a corresponding path of the first query subgraph in the query tree, determining a query result corresponding to the first query subgraph based on a subgraph query result of the first tree node in the data graph.

The apparatus embodiments correspond to the method embodiments. For specific descriptions, references can be made to the descriptions in the method embodiments.

Embodiments of this specification provide a subgraph query method, including: obtaining a plurality of query subgraphs to be queried, wherein the plurality of query subgraphs include a node, an edge, and property information of the node and the edge; performing a preliminary query in a data graph stored in a graph database based on a same portion of the plurality of query subgraphs, to obtain a first query result of the same portion, wherein the same portion is included in the plurality of query subgraphs, and is a subgraph corresponding to a same edge in the plurality of query subgraphs; and separately performing a subgraph query in the data graph based on a remaining portion of the plurality of query subgraphs and the first query result, to obtain a query result of each query subgraph.

In an embodiment, the method further includes obtaining the same portion of the plurality of query subgraphs by: merging the plurality of query subgraphs into a query tree, and using a backbone portion of the query tree as the same portion of the plurality of query subgraphs.

In an embodiment, the method further includes using a branch portion of the query tree as a remaining portion of a query subgraph.

In an embodiment, a first query subgraph of the plurality of query subgraphs includes a plurality of edges and a matching order of the plurality of edges, an edge included in the same portion has a corresponding same matching order in different query subgraphs, and the merging the plurality of query subgraphs into the query tree includes: using the edge in the first query subgraph as a tree node in the query tree, and merging the first query subgraph into the query tree based on the matching order, so that a plurality of edges included in the same portion are sequentially combined into the backbone portion of the query tree.

In an embodiment, in the first query subgraph, the edges included in the same portion have a matching order prior to a matching order of another edge, and the merging the plurality of query subgraphs into the query tree includes: merging the first query subgraph into the query tree based on the matching order of the plurality of edges in the first query subgraph and in a sequence from a root node to a leaf node in the query tree.

In an embodiment, when the first query subgraph is a subgraph to be queried first, the merging the first query subgraph into the query tree includes: using an edge in a current matching order in the first query subgraph as a parent node in the query tree based on the matching order, and using an edge in a next matching order as a child node of the parent node.

In an embodiment, when the first query subgraph is not the subgraph to be queried first, the merging the first query subgraph into the query tree includes: determining a first edge from the first query subgraph based on the matching order, determining a first tree node from the query tree in a sequence from the parent node to the child node, and performing iterative merging in the following manner: determining whether the first edge is capable of being combined with an edge of a child node of the first tree node; and if it is determined that the first edge is capable of being combined with the edge of the child node of the first tree node, updating the first edge and the first tree node; or if it is determined that the first edge is not capable of being combined with the edge of the child node of the first tree node, sequentially using the first edge and another edge in the first query subgraph as child nodes of respective levels of the first tree node.

In an embodiment, the determining whether the first edge is capable of being combined with the edge of the child node of the first tree node includes: when the first edge matches an edge of any child node included in the first tree node, determining that the first edge is capable of being combined with the edge of the any child node included in the first tree node.

In an embodiment, the tree node in the query tree has corresponding edge data, and the edge data includes an identifier of the tree node and a child node of the tree node, and an identifier used to indicate whether an edge of the tree node is a last edge in a query subgraph; and the method further includes: using a first edge in a query subgraph as a tree node in the query tree; and determining edge data of the tree node based on edge data of the first edge.

In an embodiment, the edge data of the tree node further includes a node identifier and an edge identifier that correspond to an edge, the edge identifier is used as an identifier of the tree node, and the determining the edge data of the tree node based on the edge data of the first edge includes: when a mapping relationship library records a node identifier of the first edge, determining the node identifier of the tree node based on a node identifier of a tree node corresponding to the node identifier in the mapping relationship library, wherein the mapping relationship library is configured to record a mapping relationship between node identifiers in the query subgraph and node identifiers in the query tree.

In an embodiment, the performing the preliminary query includes: performing the subgraph query in the data graph stored in the graph database based on the backbone portion of the query tree, and the separately performing the subgraph query in the data graph based on the remaining portion of the plurality of query subgraphs and the first query result includes: separately performing the subgraph query based on the branch portion of the query tree and the first query result.

In an embodiment, the performing the subgraph query in the data graph stored in the graph database based on the backbone portion of the query tree includes: when an edge of the first tree node is a to-be-queried edge, performing the subgraph query in the to-be-queried edge in the data graph based on a subgraph in the data graph that is found based on an edge of a parent node of the first tree node.

In an embodiment, the performing the subgraph query based on the branch portion of the query tree includes: when the first tree node is a last tree node in a corresponding path of the first query subgraph in the query tree, determining a query result corresponding to the first query subgraph based on a subgraph query result of the first tree node in the data graph.

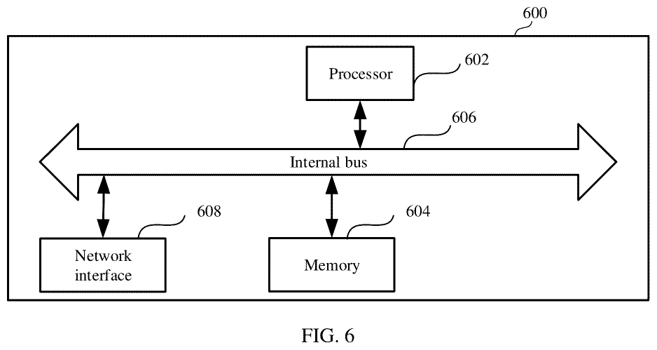

FIG. 6 is a block diagram of a subgraph query apparatus 600 according to an embodiment. For example, the subgraph query apparatus 600 may be the computing device described above. The subgraph query apparatus 600 includes a processor 602 and a memory 604 storing instructions executable by the processor 602, and may also include an internal bus 606, a network interface 608, or other needed hardware. The processor 602 is configured to perform the method described above.

Embodiments of this specification further provide a non-transitory computer-readable storage medium. The computer-readable storage medium stores a computer program. When the computer program is executed by a processor, the processor is caused to perform the method described above.

The embodiments of this specification are described in a progressive method. For same or similar parts in the embodiments, references can be made to each other. Each embodiment focuses on a difference from another embodiment. In particular, the embodiments of the storage medium and the computing device are basically similar to the method embodiments. For related parts, references can be made to some descriptions in the method embodiments.

A person skilled in the art should be aware that, functions described in embodiments of the present invention can be implemented by hardware, software, firmware, or any combination thereof. When the functions are implemented by software, the functions can be stored in a computer-readable medium or transmitted as one or more instructions or code in the computer-readable medium.

It should be understood that the above descriptions are merely example embodiments of this specification, but are not intended to limit the protection scope of this specification. Any modification, equivalent replacement, or improvement made based on this specification shall fall within the protection scope of this specification.

1. A subgraph query method, comprising:
obtaining a plurality of query subgraphs to be queried, wherein the plurality of query subgraphs comprise a node, an edge, and property information of the node and the edge;
performing a preliminary query in a data graph stored in a graph database based on a same portion of the plurality of query subgraphs, to obtain a first query result of the same portion, wherein the same portion is comprised in the plurality of query subgraphs, and is a subgraph corresponding to a same edge in the plurality of query subgraphs; and
separately performing a subgraph query in the data graph based on a remaining portion of the plurality of query subgraphs and the first query result, to obtain a query result of each query subgraph.

2. The method according to claim 1, further comprising obtaining the same portion of the plurality of query subgraphs by:
merging the plurality of query subgraphs into a query tree, and using a backbone portion of the query tree as the same portion of the plurality of query subgraphs.

3. The method according to claim 2, further comprising using a branch portion of the query tree as a remaining portion of a query subgraph.

4. The method according to claim 2, wherein a first query subgraph of the plurality of query subgraphs comprises a plurality of edges and a matching order of the plurality of edges, an edge comprised in the same portion has a corresponding same matching order in different query subgraphs, and the merging the plurality of query subgraphs into the query tree comprises:
using the edge in the first query subgraph as a tree node in the query tree, and merging the first query subgraph into the query tree based on the matching order, so that a plurality of edges comprised in the same portion are sequentially combined into the backbone portion of the query tree.

5. The method according to claim 4, wherein in the first query subgraph, the edges comprised in the same portion have a matching order prior to a matching order of another edge, and the merging the plurality of query subgraphs into the query tree comprises:
merging the first query subgraph into the query tree based on the matching order of the plurality of edges in the first query subgraph and in a sequence from a root node to a leaf node in the query tree.

6. The method according to claim 5, wherein when the first query subgraph is a subgraph to be queried first, the merging the first query subgraph into the query tree comprises:
using an edge in a current matching order in the first query subgraph as a parent node in the query tree based on the matching order, and using an edge in a next matching order as a child node of the parent node.

7. The method according to claim 6, wherein when the first query subgraph is not the subgraph to be queried first, the merging the first query subgraph into the query tree comprises:
determining a first edge from the first query subgraph based on the matching order, determining a first tree node from the query tree in a sequence from the parent node to the child node, and performing iterative merging in the following manner:
determining whether the first edge is capable of being combined with an edge of a child node of the first tree node; and
if it is determined that the first edge is capable of being combined with the edge of the child node of the first tree node, updating the first edge and the first tree node; or
if it is determined that the first edge is not capable of being combined with the edge of the child node of the first tree node, sequentially using the first edge and another edge in the first query subgraph as child nodes of respective levels of the first tree node.

8. The method according to claim 7, wherein the determining whether the first edge is capable of being combined with the edge of the child node of the first tree node comprises:
when the first edge matches an edge of any child node comprised in the first tree node, determining that the first edge is capable of being combined with the edge of the any child node comprised in the first tree node.

9. The method according to claim 4, wherein the tree node in the query tree has corresponding edge data, and the edge data comprises an identifier of the tree node and a child node of the tree node, and an identifier used to indicate whether an edge of the tree node is a last edge in a query subgraph; and
the method further comprises:
using a first edge in a query subgraph as a tree node in the query tree; and
determining edge data of the tree node based on edge data of the first edge.

10. The method according to claim 9, wherein the edge data of the tree node further comprises a node identifier and an edge identifier that correspond to an edge, the edge identifier is used as an identifier of the tree node, and the determining the edge data of the tree node based on the edge data of the first edge comprises:
when a mapping relationship library records a node identifier of the first edge, determining the node identifier of the tree node based on a node identifier of a tree node corresponding to the node identifier in the mapping relationship library, wherein the mapping relationship library is configured to record a mapping relationship between node identifiers in the query subgraph and node identifiers in the query tree.

11. The method according to claim 3, wherein the performing the preliminary query comprises: performing the subgraph query in the data graph stored in the graph database based on the backbone portion of the query tree, and
the separately performing the subgraph query in the data graph based on the remaining portion of the plurality of query subgraphs and the first query result comprises: separately performing the subgraph query based on the branch portion of the query tree and the first query result.

12. The method according to claim 11, wherein the performing the subgraph query in the data graph stored in the graph database based on the backbone portion of the query tree comprises:
when an edge of the first tree node is a to-be-queried edge, performing the subgraph query in the to-be-queried edge in the data graph based on a subgraph in the data graph that is found based on an edge of a parent node of the first tree node.

13. The method according to claim 12, wherein the performing the subgraph query based on the branch portion of the query tree comprises:
when the first tree node is a last tree node in a corresponding path of the first query subgraph in the query tree, determining a query result corresponding to the first query subgraph based on a subgraph query result of the first tree node in the data graph.

14. A subgraph query apparatus, comprising:
a processor; and
a memory storing instructions executable by the processor,
wherein the processor is configured to:
obtain a plurality of query subgraphs to be queried, wherein the plurality of query subgraphs comprise a node, an edge, and property information of the node and the edge;
perform a preliminary query in a data graph stored in a graph database based on a same portion of the plurality of query subgraphs, to obtain a first query result of the same portion, wherein the same portion is comprised in the plurality of query subgraphs, and is a subgraph corresponding to a same edge in the plurality of query subgraphs; and
separately perform a subgraph query in the data graph based on a remaining portion of the plurality of query subgraphs and the first query result, to obtain a query result of each query subgraph.

15. The apparatus according to claim 14, wherein the processor is further configured to obtain the same portion of the plurality of query subgraphs by:
merging the plurality of query subgraphs into a query tree, and using a backbone portion of the query tree as the same portion of the plurality of query subgraphs.

16. The apparatus according to claim 15, wherein the processor is further configured to use a branch portion of the query tree as a remaining portion of a query subgraph.

17. The apparatus according to claim 15, wherein a first query subgraph of the plurality of query subgraphs comprises a plurality of edges and a matching order of the plurality of edges, an edge comprised in the same portion has a corresponding same matching order in different query subgraphs, and in merging the plurality of query subgraphs into the query tree, the processor is further configured to:
use the edge in the first query subgraph as a tree node in the query tree, and merge the first query subgraph into the query tree based on the matching order, so that a plurality of edges comprised in the same portion are sequentially combined into the backbone portion of the query tree.

18. The apparatus according to claim 17, wherein the tree node in the query tree has corresponding edge data, and the edge data comprises an identifier of the tree node and a child node of the tree node, and an identifier used to indicate whether an edge of the tree node is a last edge in a query subgraph; and
the processor is further configured to:
use a first edge in a query subgraph as a tree node in the query tree; and
determine edge data of the tree node based on edge data of the first edge.

19. The apparatus according to claim 18, wherein the edge data of the tree node further comprises a node identifier and an edge identifier that correspond to an edge, the edge identifier is used as an identifier of the tree node, and in determining the edge data of the tree node based on the edge data of the first edge, the processor is further configured to:
when a mapping relationship library records a node identifier of the first edge, determine the node identifier of the tree node based on a node identifier of a tree node corresponding to the node identifier in the mapping relationship library, wherein the mapping relationship library is configured to record a mapping relationship between node identifiers in the query subgraph and node identifiers in the query tree.

20. A non-transitory computer-readable storage medium storing a computer program that, when executed by a processor, causes the processor to perform a subgraph query method, the method comprising:
obtaining a plurality of query subgraphs to be queried, wherein the plurality of query subgraphs comprise a node, an edge, and property information of the node and the edge;
performing a preliminary query in a data graph stored in a graph database based on a same portion of the plurality of query subgraphs, to obtain a first query result of the same portion, wherein the same portion is comprised in the plurality of query subgraphs, and is a subgraph corresponding to a same edge in the plurality of query subgraphs; and
separately performing a subgraph query in the data graph based on a remaining portion of the plurality of query subgraphs and the first query result, to obtain a query result of each query subgraph.
